(19) United States
(12) Patent Application Publication
(10) Pub. No.: US 2026/0138899 A1
(43) Pub. Date: May 21, 2026

(54) COAL-DUST WATER FLOCCULANT USING CHITOSAN

(71) Applicants: Jae Woon NAH, Suncheon-si, Jeollanam-do (KR); KITTOZITE CO. LTD., Guri-si, Gyeonggi-do (KR)

(72) Inventors: Jae Woon NAH, Suncheon-si, Jeollanam-do (KR); Gyeong Won JEONG, Gwangju (KR); Woong Gil HONG, Gwangju (KR)

(73) Assignees: Jae Woon NAH, Suncheon-si, Jeollanam-do (KR); KITTOZITE CO. LTD., Guri-si, Gyeonggi-do (KR)

(21) Appl. No.: 18/697,591

(22) PCT Filed: Apr. 21, 2022
(86) PCT No.: PCT/KR2022/005688

§ 371 Date: Apr. 1, 2024

(30) Foreign Application Priority Data
Sep. 30, 2021 (KR) 10-2021-0129553

(51) Int. Cl. C02F 1/52; C02F 103/10

(52) U.S. Cl. CPC C02F 1/5272; C02F 1/5236; C02F 1/5263; C02F 2103/10

(57) ABSTRACT

The present invention relates to a coal-dust water flocculant configured to remove fine dust contained in coal-dust water generated during a process of spraying water on coal and the flocculant comprises chitosan and lactic acid. Therefore, the coal-dust water flocculant of the present invention has the advantages of having excellent flocculation efficiency for fine dust contained in the coal-dust water and a high fine dust flocculation rate and being completely harmless to the human body and the environment.

### TECHNICAL FIELD

The present invention relates to a coal-dust water flocculant using chitosan, and more particularly, to a coal-dust water flocculant that exhibits excellent flocculation efficiency for fine dust contained in coal-dust water and has an excellent flocculation rate of fine dust.

### BACKGROUND ART

Coal-fired power plants use coal as the main raw material, and dust generation and spontaneous ignition of coal occur during the movement of coal. To prevent this, a water spraying process is performed. As a result, wastewater referred to as “coal-dust water,” which is a mixture of coal dust and water, flows out, thereby causing environmental pollution.

Meanwhile, various methods have been used to treat such coal-dust water. Korean Patent Publication No. 2002-0063736 discloses a method of flocculating pulverized coal generated in a coal drying process, which is characterized by reducing an amount of pulverized coal generated in a coking coal charging process by flocculating pulverized coal, which is collected in a dust collector of a coal moisture control system, into a carbonaceous material and adding dried coking coal to suppress the redifferentiation of the flocculated body. However, there were limitations in applying this technology to coal-dust water in which fine dust of coal is dispersed in water.

Therefore, there is an urgent need for the development of a novel coal-dust water flocculant that is easily applicable to coal-dust water in which fine dust of coal is dispersed in water.

### DISCLOSURE

### Technical Problem

Accordingly, in order to solve the above problems, the present inventors have found that the fine dust of coal contained in coal-dust water can be very efficiently removed by flocculation using chitosan and lactic acid. Therefore, the present invention has been completed based on this finding.

### Technical Solution

A coal-dust water flocculant according to one exemplary embodiment of the present invention is a coal-dust water flocculant configured to remove fine dust contained in coal-dust water generated during a process of spraying water on coal and is characterized in that the flocculant comprises chitosan and lactic acid.

The coal-dust water flocculant according to one exemplary embodiment of the present invention is characterized in that the flocculant further comprises copper powder.

The coal-dust water flocculant according to one exemplary embodiment of the present invention wherein the chitosan is treated at a concentration of 4 ppm in the coal-dust water.

### Advantageous Effects

A coal-dust water flocculant according to the present invention has the advantages of
having excellent flocculation efficiency for fine dust contained in the coal-dust water and a high fine dust flocculation rate and being completely harmless to the human body and the environment.

### DESCRIPTION OF DRAWINGS

FIG. 1 is an image showing changes in transmittance of coal-dust water measured after the coal-dust water is treated with various concentrations of a flocculant.

FIG. 2 is an image showing changes in transmittance of coal-dust water measured over time after the coal-dust water is treated with various concentrations of a flocculant.

FIG. 3 shows the results confirmed by a method of calculating suspended solids (SS) by observing the suspended solid removal efficiency from coal-dust water over time after the coal-dust water is treated with a 0.2% flocculant at an optimal concentration of 4 ppm.

FIG. 4 shows the results of an MTT assay performed on normal HEK293 and L929 cells to evaluate the toxicity of the 0.2% flocculant. These results show that the cell viability was over 80% at all concentrations of the flocculant when the cells were treated with the flocculant, indicating that the flocculant had no toxicity at all.

### BEST MODE

Prior to describing the present invention in more detail, the terms and words used in the present specification and the claims should not be interpreted as being limited to typical meanings or dictionary definitions, but should be interpreted as having meanings and concepts which are consistent with the technical scope of the present invention based on the principle that an inventor can appropriately define the concepts of terms to describe his/her invention in the best way. Therefore, the configurations of the embodiments described in this specification are just preferred examples of the present invention but do not represent all of the technical spirit of the present invention. Thus, the present invention should be construed as comprising all the equivalents and modifications included in the spirit and scope of the present invention at the time of filing this application.

In the present invention, in order to solve the problems of the outflow of wastewater referred to as “coal-dust water” in which coal dust and water are mixed together, which causes environmental pollution, a chitosan-based natural flocculant capable of purifying water by flocculating even fine dust was developed.

By adding various concentrations of a flocculant to coal-dust water, it was found that the optimal adsorption concentration was 4 ppm, and it was confirmed that a material developed based on transmittance and coal-dust removal efficiency has a very excellent coal-dust flocculation ability.

Also, the present inventors found that the flocculant developed in the present invention is a material that can effectively flocculate coal dust without having a negative impact on humans and the natural ecosystem by proving that the flocculant has no toxicity when the cytotoxicity of the flocculant was evaluated through an MTT assay.

Thermal power generation is currently one of the methods of producing electrical energy that is closely related to our daily lives. In the case of thermal power generation, electricity is generated by turning a turbine with steam produced by burning coal. Thermal power generation accounts for the largest proportion of electricity in Korea and also has the advantage of low costs related to location and initial development. In Korea, there are 59 coal-fired power plants, 29 of which are located in South Chungcheong Province. Also, when including the new power plants scheduled to be built by 2029, Korea will have 79 coal-fired power plants across the country.

Coal-fired power plants use coal as the main raw material, and the coal used to produce steam is stored in a place referred to as a coal silo. Dust generation and spontaneous combustion of coal occur when coal is stored in a coal silo or during the movement of coal. To prevent this, a water spraying process is performed.

As a result, wastewater referred to as “coal-dust water,” which is a mixture of coal dust and water, flows out. This wastewater is collected through pipes and undergoes a sedimentation process. Thereafter, the supernatant is moved to a landfill.

The amount of coal-dust water generated per day ranges from as little as 2 tons to as much as 3 tons per thermal power plant. Although coal-dust water is generated in large quantities and undergoes a sedimentation process, to date, fine dust does not settle and is moved to the landfill as it is, becoming a major environmental pollution problem.

In order to solve this problem, the present inventors developed a natural flocculant that can purify water by flocculating even fine dust using chitosan and attempted to prove its applicability.

Chitosan is a substance obtained by treating chitin, which is a natural polymer distributed in crustaceans such as crabs and shrimp, cartilaginous mollusks such as squid, and the like, with a concentrated alkali. It is a biodegradable natural polysaccharide composed of two monomer units, D-glucosamine and N-acetyl D-glucosamine, linked via a β-(1,4)-glycosidic bond.

It is well known that chitosan has excellent physiological activities such as an anti-cancer effect, cholesterol reduction, immune activity, antibacterial properties, and the like. Fields of application using chitosan include cosmetics, water treatment, pharmaceuticals, food, the bio industry, and the like. In recent years, research in the medical field is expanding.

In the case of chitosan used in water treatment, it has been widely applied as a purifier and flocculant through membranes by taking advantage of chitosan's strong positive charge characteristic. Also, because chitosan has low toxicity, natural flocculants developed using chitosan have the great advantage of not causing environmental pollution or affecting the ecosystem.

In the present invention, in order to solve the problem of environmental pollution, verifying the ability of chitosan to flocculate coal dust by flocculating coal dust using the strong positive charge of chitosan, increasing the sedimentation rate to recover and reuse the settled coal dust, and recycling the recovered water.

### [Reagents and Materials]

The coal-dust water used in an experiment to prove the effect of the present invention was collected from the Hadong thermal power plant in South Gyeongsang Province, stored at room temperature, and used in this study. Chitosan (viscosity: 1,188 cP) used as an adsorbent was purchased from NANO BIOTECH Sokcho Co., Korea, and lactic acid used to solubilize insoluble chitosan was purchased from SIGMA-ALDRICH (USA). HEK293 and L929 cells used for a cytotoxicity test were purchased from the American Type Culture Collection (ATCC, Korea) and cultured using a Dulbecco's modified Eagles medium (DMEM) containing 10% fetal bovine serum (FBS). Ethylenediamineteteraacetic acid (EDTA), 3-3-[4,5-dimethylthiazol-2-yl]-2,5-diphenyltetrazolium bromide (MTT), and DMEM used in cell experiments were purchased from Sigma-Aldrich (USA). Solvents and reagents used in other experiments were purchased as first-grade reagents and used without purification.

### [Preparation of Chitosan Solution]

A chitosan solution used for flocculation of coal-dust water was prepared as follows. 10 g of chitosan (viscosity: 1,181 cP) was dispersed in 1 L of distilled water, and lactic acid was then added at a weight ratio of 60% of chitosan and stirred for 24 hours to finally prepare an aqueous 1% chitosan solution, which was used in this study of the present invention.

### [Establishment of Optimal Coal-Dust Water Flocculation Concentration of Chitosan Solution]

Coal-dust water was prepared in the same amount as the 1% chitosan solution. The 1% chitosan solution was diluted to concentrations of 0.1, 0.2, 0.4, and 0.8%, respectively, and treated with coal-dust water. The optimal coal-dust water flocculation concentration was selected in consideration of the flocculation time and degree of flocculation.

[Measurement of Change in Transmittance of Coal-Dust Water after Treatment with Flocculant]

To determine the effect of the flocculant on coal-dust water flocculation, the change in transmittance of coal-dust water after treatment with the flocculant was confirmed using an ultraviolet-vis spectrometer (UV 1601, Shimadzu, Japan). A 0.2% chitosan solution with an optimal concentration of 4 ppm was added to a beaker filled with 50 mL of coal-dust water and stirred. Thereafter, 2 mL of the supernatant was taken to measure transmittance over time. At this time, in order to clearly prove the flocculation effect of the flocculant, 2 mL of the control group that was not treated with the flocculant was taken at the same time to measure transmittance.

[Suspended Solid Removal Efficiency in Coal-Dust Water after Treatment with Flocculant]

To confirm the suspended solid removal efficiency of the flocculant in coal-dust water, suspended solid (SS) removal efficiency was applied and calculated. 100 mL of coal-dust water was treated with a 0.2% flocculant with an optimal concentration of 4 ppm and stirred for 20, 40, 160, and 320 seconds. Thereafter, 30 mL of each supernatant was taken, and suspended solids were filtered through a glass filter (Whatman, 47 mm Diameter Circle, 100 Pack, UK), and dried at 50° C. for 24 hours. The amount of suspended solids in the dried filter was calculated using Equation 1 below to finally determine the suspended solid removal efficiency of the flocculant.

$$Suspended solid removal efficiency ( \% ) = 100 - [ ( \frac{\begin{matrix}( Suspended solids - containing filter paper ( g ) - \\ Filter paper ( g )\end{matrix}}{Coal - dust water ( L )} \qquad [ Equation 1 ]$$

[Measurement of Change in pH of Coal-Dust Water after Treatment with Flocculant]

After coal-dust water was treated with the flocculant, the change in pH was measured using a pH meter (Thermo Fisher Scientific, Orion 3-star benchtop pH meter, USA). First, the pH of 50 mL of coal-dust water was measured, which was then treated with 4 and 8 ppm of a 0.2% flocculant, respectively. Thereafter, the pH change was observed.

### [Evaluation of Toxicity of Chitosan Flocculant]

A cytotoxicity test was conducted to confirm the toxicity of the 0.2% chitosan solution prepared at the optimal concentration through the above experiment. Cytotoxicity was determined through a 3-3-(4,5-dimethyl-2-thiazolyl)-2,5-diphenyl-2H-tetrazolium bromide (MTT) assay and measured using normal cells, for example, human embryonic kidney cells (HEK293) and murine fibroblast cells (L929). HEK293 and L929 cells were cultured at 37% in a DMEM medium in a culture dish in a 5° C. CO₂ incubator, detached with trypsin-EDTA, and then counted. Thereafter, the cells were seeded at 5×10³ cells/well in a 96-well-plate and cultured for 2 days to safely attach the cells. Then, a 0.2% chitosan solution was diluted to concentrations of 200, 100, 50, 25, 12.5 6.25 3.13 1.56 μL/mL using DMEM, treated, and cultured for 48 hours. Subsequently, 30 μL of an MTT reagent was treated at a concentration of 1 mg/mL and then cultured for 4 hours in an incubator to reduce the reaction product, and the entire MTT reagent was then removed. Afterwards, a 96-well plate was treated with DMSO at a concentration of 200 μL/well to form formazan, and the absorbance was finally measured at 560 nm and 670 nm using a microplate reader. Cell viability was calculated according to Equation 2 below.

$$ODvalue = ( OD 560 nm - OD 670 nm ) \qquad [ Equation 2 ]$$

$$Cell viability ( \% ) = \frac{{OD}_{sample} - {OD}_{blank}}{{OD}_{control} - {OD}_{blank}} \times 100$$

### [Establishment of Coal-Dust Water Flocculation Effect and Optimal Concentration of Flocculant]

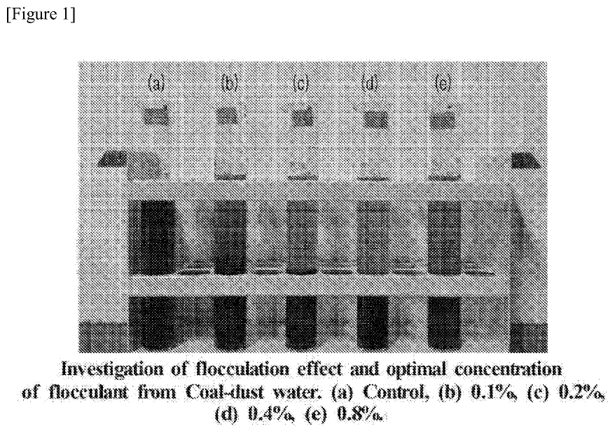

To determine the coal-dust flocculation effect and optimal concentration of chitosan, various concentrations of chitosan were treated. 50 mL of coal-dust water was treated with 100 μL of the flocculant at concentrations of 0.1, 0.2, 0.4, and 0.8%, respectively, to observe the degree of flocculation. As a result, it was confirmed that flocculant adsorbed and settled rapidly at all concentrations at which coal-dust water was treated with the flocculant. Among them, the flocculant exhibited the best efficacy when coal-dust water was treated with the flocculant at a concentration of 0.2% (FIG. 1).

It is believed that this is because chitosan containing an amine (—NH₂) functional group has a positive charge, and the density increases when flocculation occurs due to the electrostatic interaction of the chitosan with coal dust, which exhibits a negative charge. These results confirmed that the 0.2% flocculant had the best flocculation ability at a concentration of 4 ppm.

### [Evaluation of Transmittance According to Coal-Dust Flocculation Time and Measurement of pH Change]

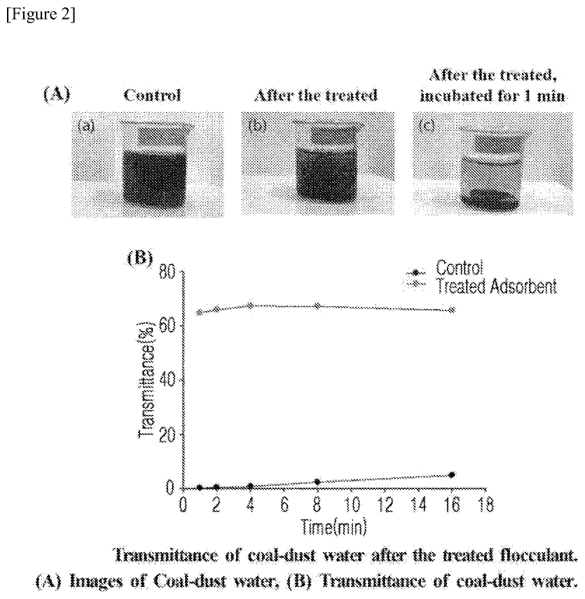

To further determine the coal-dust flocculation efficacy of the flocculant developed in this study, transmittance over time was observed (FIG. 2 and Table A).

TABLE A
Transmittance of Coal-dust Water according to Treated Flocculant

| | Transmittance (%) | | | | |
|---|---|---|---|---|---|
| | Time (min) | | | | |
| Sample | 1 | 2 | 4 | 8 | 16 |
| Control | 0.25 ± 0.07 | 0.5 ± 0.00 | 0.85 ± 0.07 | 2.45 ± 0.07 | 4.95 ± 0.07 |
| Treated flocculant | 64.7 ± 0.14 | 65.8 ± 0.00 | 67.3 ± 0.07 | 67.1 ± 0.00 | 65.6 ± 0.07 |

As can be seen through Table A and FIG. 2, it was observed that the coal dust quickly flocculated and settled down within one minute when transmittance over time was observed after treatment with the flocculant. Then, the supernatant of coal-dust water was taken to measure transmittance. As a result, it can be seen that the transmittance was 64% or more. This showed that the flocculant had a very excellent flocculation ability because there was a difference in transmittance that was 60-fold or higher compared to the control group that was not treated with the flocculant.

Also, it was confirmed that there was almost no difference in transmittance after an elapsed time of 1 minute or more, indicating that the flocculant was able to flocculate all the coal dust within 1 minute.

In addition, the pH change according to the treatment of the coal-dust water with the flocculant in the coal-dust water is summarized in Table B below.

TABLE B
pH Change of Coal-cording to Treated F

Quantity of treated flocculant (ppm)

| | | |
|---|---|---|
| Control | 4 | 8 |

| | | | |
|---|---|---|---|
| pH | 7.93 | 7.75 | 7.58 |

As summarized in Table B above, it was confirmed that the initial pH value of 50 mL of coal-dust water was 7.93, indicating a slightly alkaline pH, and that the pH values of coal-dust water were 7.75 and 7.58, respectively, when the flocculant was added to coal-dust water at concentrations of 4 ppm and 8 ppm.

As the amount of added flocculant increases, the pH of coal-dust water decreases, but since the pH changes close to neutral, it is believed that there will be no problems at all in the natural ecosystem. Based on these results, it was confirmed that the flocculant developed in this study is an excellent material capable of purifying water while flocculating coal dust in a short period of time, and thus is able to be used as a flocculant for coal dust.

[Evaluation of Suspended Solid Removal Efficiency and Toxicity of Coal-Dust Water after Treatment with Flocculant]

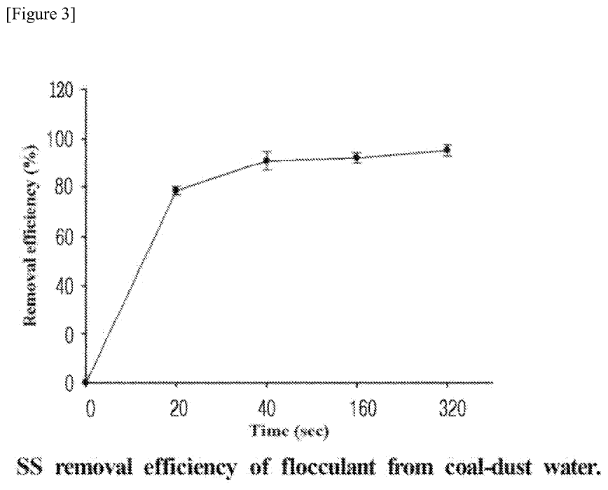

FIG. 3 and Table C show the results confirmed by a method of calculating suspended solids (SS) by observing the suspended solid removal efficiency in coal-dust water over time after the coal-dust water was treated with a 0.2% flocculant at an optimal concentration of 4 ppm.

TABLE C
SS Removal Efficiency according to Treated Flocculan

| Time (sec) | 0 | 20 | 40 | 160 | 320 |
|---|---|---|---|---|---|
| Removal | 0 | 78.4 ± 1.8 | 90.9 ± 4.0 | 92.2 ± 2.2 | 95.3 ± 2.2 |
| efficiency (%) | | | | | |

As summarized in Table C and FIG. 3, it was confirmed that the initial suspended solid removal efficiency was 0%, but the removal efficiency was 80% after 20 seconds had elapsed. After treatment with the flocculant and gradually increased as time elapsed, and the flocculant exhibited a very excellent removal efficiency of 95% or more at 320 seconds.

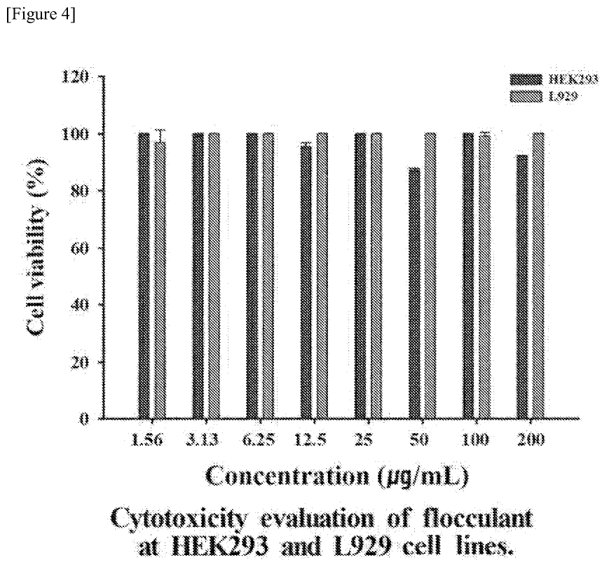

Also, to evaluate the toxicity of the 0.2% flocculant, an MTT assay was performed on normal cells, HEK293 and L929 cells. As a result, it was confirmed that the flocculant did not have any toxicity at all because it exhibited a cell viability of 80% or more at all concentrations at which coal-dust water was treated with the flocculant (FIG. 4).

Based on these results, it was proven that the flocculant according to the present invention is a very safe material for humans and the natural ecosystem because the flocculant had a very excellent coal-dust flocculation ability and did not have any cytotoxicity. Therefore, it is believed that the flocculant of the present invention can be applied as a flocculant for coal dust and will be helpful in preventing environmental pollution.

### MODE FOR INVENTION

The present inventors conducted additional experiments in which other additives were added to the coal-dust water flocculant along with chitosan.

### Example 1

A flocculant was prepared by mixing 10 g of chitosan, 6 g of lactic acid, 1 liter of water, 5 g of copper powder having an average particle diameter of approximately 0.1 μm, 10 g of rosin powder, 10 g of ginkgo fruit juice, and 10 g of persimmon fruit juice. Commercially available rosin powder was purchased and used as the rosin powder, and the ginkgo fruit juice was prepared by harvesting ginkgo fruits, soaking the ginkgo fruits in water for 3 days, collecting the ginkgo fruits, removing the hard ginkgo seeds, and completely crushing the remaining ginkgo pulp into juice. The persimmon fruit juice was prepared by removing the seeds of unripe, blue, astringent persimmons and completely crushing the unpeeled persimmon pulp into juice.

### [Comparative Example 1]—Removal of Copper Powder in Example 1

A flocculant was prepared by mixing 10 g of chitosan, 6 g of lactic acid, 1 liter of water, 10 g of rosin powder, 10 g of ginkgo fruit juice, and 10 g of persimmon fruit juice. The rosin powder, the ginkgo fruit juice, and the persimmon fruit juice were prepared in the same manner as in Example 1 and used.

### [Comparative Example 2]—Removal of Rosin Powder in Example 1

A flocculant was prepared by mixing 10 g of chitosan, 6 g of lactic acid, 1 liter of water, 5 g of copper powder having an average particle diameter of approximately 0.1 μm, 10 g of ginkgo fruit juice, and 10 g of persimmon fruit juice. The ginkgo fruit juice and the persimmon fruit juice were prepared in the same manner as in Example 1 and used.

### [Comparative Example 3]—Removal of Ginkgo Fruit Juice in Example 1

A flocculant was prepared by mixing 10 g of chitosan, 6 g of lactic acid, 1 liter of water, 5 g of copper powder having an average particle diameter of approximately 0.1 μm, 10 g of rosin powder, and 10 g of persimmon fruit juice. The rosin powder and the persimmon fruit juice were prepared in the same manner as in Example 1 and used.

### [Comparative Example 4]—Removal of Persimmon Fruit Juice in Example 1

A flocculant was prepared by mixing 10 g of chitosan, 6 g of lactic acid, 1 liter of water, 5 g of copper powder having an average particle diameter of approximately 0.1 μm, 10 g of rosin powder, and 10 g of ginkgo fruit juice. The rosin powder and the ginkgo fruit juice were prepared in the same manner as in Example 1 and used.

After 10 g of each of the flocculants prepared in Example 1 and Comparative Examples 1 to 4 was evenly diluted in 1 liter of coal-dust water, the supernatant of the diluted solution was collected, and light transmittance over time was measured. The results are shown in Table 1 below.

TABLE 1

| | 1 | 2 | 4 | 8 | 16 |
|---|---|---|---|---|---|
| Classification | minute | minutes | minutes | minutes | minutes |
| Example 1 | 71.5 | 72.6 | 73.4 | 74.6 | 75.4 |
| Comparative | 65.7 | 66.8 | 67.5 | 68.8 | 69.7 |
| Example 1 | | | | | |
| Comparative | 65.9 | 66.9 | 68.1 | 69.1 | 70.1 |
| Example 2 | | | | | |
| Comparative | 65.6 | 66.7 | 67.4 | 68.9 | 69.8 |
| Example 3 | | | | | |
| Comparative | 65.2 | 66.4 | 67.3 | 68.2 | 69.1 |
| Example 4 | | | | | |

Referring to the results in Table 1 above, it can be seen that the flocculant according to Example 1 had the best coal dust flocculation efficiency.

After 10 g of each of the flocculants prepared in Example 1 and Comparative Examples 1 to 4 was exposed to strong sunlight for 5 hours a day for 5 days, each of the flocculants was evenly diluted in 1 liter of coal-dust water. Thereafter, the supernatant of the diluted solution was collected, and light transmittance was measured over time. The results are shown in Table 2 below.

TABLE 2

| | 1 | 2 | 4 | 8 | 16 |
|---|---|---|---|---|---|
| Classification | minute | minutes | minutes | minutes | minutes |
| Example 1 | 71.4 | 72.5 | 73.3 | 74.5 | 75.3 |
| Comparative | 62.2 | 63.7 | 64.4 | 65.5 | 66.5 |
| Example 1 | | | | | |
| Comparative | 62.8 | 63.7 | 65.2 | 65.9 | 66.5 |
| Example 2 | | | | | |
| Comparative | 61.7 | 62.5 | 63.4 | 64.5 | 64.9 |
| Example 3 | | | | | |
| Comparative | 62.1 | 63.0 | 64.1 | 64.9 | 65.5 |
| Example 4 | | | | | |

Referring to the results in Table 2 above, it can be seen that the flocculant according to Example 1 had almost no change in physical properties when exposed to strong ultraviolet rays of sunlight.

1. A coal-dust water flocculant configured to remove fine dust contained in coal-dust water generated during a process of spraying water on coal,
wherein the flocculant comprises chitosan and lactic acid.

2. The coal-dust water flocculant according to claim 1, wherein the flocculant further comprises copper powder.

3. The coal-dust water flocculant according to claim 1, wherein the chitosan is treated at a concentration of 4 ppm in the coal-dust water.
